(19) United States
(12) Patent Application Publication
(10) Pub. No.: US 2014/0055249 A1
(43) Pub. Date: Feb. 27, 2014

(54) RFID SECURITY TAG BASED MONITORING SYSTEM AND DETACHERS FOR USE THEREWITH

(71) Applicant: Glen Walter Garner, Toronto (CA)

(72) Inventor: Glen Walter Garner, Toronto (CA)

(21) Appl. No.: 13/979,080

(22) PCT Filed: Jan. 10, 2012
(86) PCT No.: PCT/CA12/50010

§ 371 Date: Oct. 25, 2013

Related U.S. Application Data
(60) Provisional application No. 61/431,318, filed on Jan. 10, 2011.

(51) Int. Cl. G08B 13/24; E05B 73/00

(52) U.S. Cl. CPC G08B 13/2434; G08B 13/2451; E05B 73/0047
USPC 340/10.51; 70/57.1

(57) ABSTRACT

A smart detacher includes a detacher and an RFID reader. The smart detacher may be a handheld detacher or a secondary detacher. A method of monitoring using a security tag with an RFID chip therein and an detacher having an RFID reader operably connected thereto comprising the steps of: writing information onto the RFID chip; attaching the security tag to a product; detaching the security tag from the product and reading the information on the RFID chip; and forwarding the information to a control system.

### FIELD OF THE INVENTION

This invention relates to security tags and in particular security tags with RFID chip and antennae therein, tag detachers with RFID readers therein and a system for tracking information from the RFID chip.

### BACKGROUND OF THE INVENTION

There is an on-going problem for retailers in regard to theft or slippage. This may be from shop lifting, internal theft or co-ordinated theft using employees and third parties. Accordingly retailers are interested in new solutions to help them manage their merchandise from time of manufacture to the point of sale.

Currently RFID (radio-frequency identification) is only used by a few retailers. Typically it is being used by labeling their merchandise with an adhesive RFID label. This method of using RFID is very labor intensive and thus very costly. Typically the retailer is using hand readers in conjunction with the adhesive RFID tags to record the merchandise they have in stock. For some retailers it is important for them to know the location of a product in the store. For example is it in a display at a particular location, is it on a hold rack or is it in a changing area waiting to be re-shelved. If a retailer does not know the location of the stock and is able to locate it in a timely manner they may lose the sale. Alternatively they try to locate it at another store, incur the cost of shipping from the other location and then expecting the customer to return to purchase the product, thus making the sale less likely. Accordingly it may be very expensive to implement such a system for all of the retailer's products.

On the other hand RFID technology is incredibly powerful and it would be advantageous for a retailer to take advantage of RFID technology. Further it would be advantageous for retailers to implement RFID technology without considerable infrastructure costs.

### SUMMARY OF THE INVENTION

In one embodiment there is a smart detacher for use in association with a tag having an RFID chip therein which includes a detacher and an RFID reader.

The smart detacher may be a handheld detacher and a stationary detacher. The detacher may be a detacher for spring lock and/or a magnetic lock. The detacher may be an electromagnetic detacher. The detacher may include an arcuate arm for detaching the spring lock.

The RFID reader may be an RFID reader and writer. The RFID reader may be operably connected to a control system. The RFID reader may be connected to the control system by way of one of a wireless connection and a wired connection.

The RFID reader may be operably connected to a power source. The power source may be one of a battery and a power socket.

In one embodiment there is a method of monitoring using a security tag with an RFID chip therein and an detacher having an RFID reader operably connected thereto comprising the steps of: writing information onto the RFID chip; attaching the security tag to a product; detaching the security tag from the product and reading the information on the RFID chip; and forwarding the information to a control system.

The control system may further record a date and a time of reading the information from the RFID chip.

The RFID reader may be associated with a cash register and the information from the RFID chip and the date and time of reading the information is compared to information from the cash registered.

Discrepancies between the information from the RFID chip and the cash registered may be red flagged.

The detacher may be one of a handheld detacher and a stationary detacher.

The security tag may be attached to the product at a manufacturer of the product.

The information may include a predetermined identification code and further including the step of determining if the information read includes the predetermined identification code and if not red flagging the product.

RFID readers may be positioned where products enter a store and the information may be read when the product enters the store.

RFID readers may be located at predetermined locations around a store and periodically information may be read within range of each RFID readers and the location of predetermined identification code may be determined relative an RFID reader.

RFID readers may be located in a change rooms and a number of tags may be read entering the change room and a number of tags may be read leaving the change room and red flags may be determined when these numbers are not the same.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of a hand detacher and showing a security tag being inserted therein;

FIG. 2 is a perspective view of a hand detacher similar to that shown in FIG. 1 and showing a security tag inserted therein;

FIG. 3 is a perspective view of a hand detacher similar to that shown in FIG. 2 and showing a pin being removed from the security tag;

FIG. 4 is a perspective view of a hand detacher and security tag similar to that shown in FIG. 3 but showing one side of the outside casing of the hand detacher removed;

FIG. 5 is a perspective view of a hand detacher similar to that shown in FIG. 2 but showing a slimmer security tag;

FIG. 6 is a perspective view of a hand detacher similar to that shown in FIG. 2 but showing a wider security tag;

FIG. 7 is a perspective view of a hand detacher similar to that shown in FIG. 2 but including an arcuate arm spring lock detacher;

FIG. 8 is a perspective view of a hand detacher similar to that shown in FIG. 7 but showing it with a security tag therein;

FIG. 9 is a perspective view of a security tag with a stationary detacher;

FIG. 10 is a perspective view of a stationary detacher in use with a security package having multiple locks;

FIG. 11 is a top view of a stationary detacher in use with a an alternate security package having multiple locks; and

FIG. 12 is a perspective view of a stationary detacher in use with an alternate security package having multiple locks.

### DETAILED DESCRIPTION OF THE INVENTION

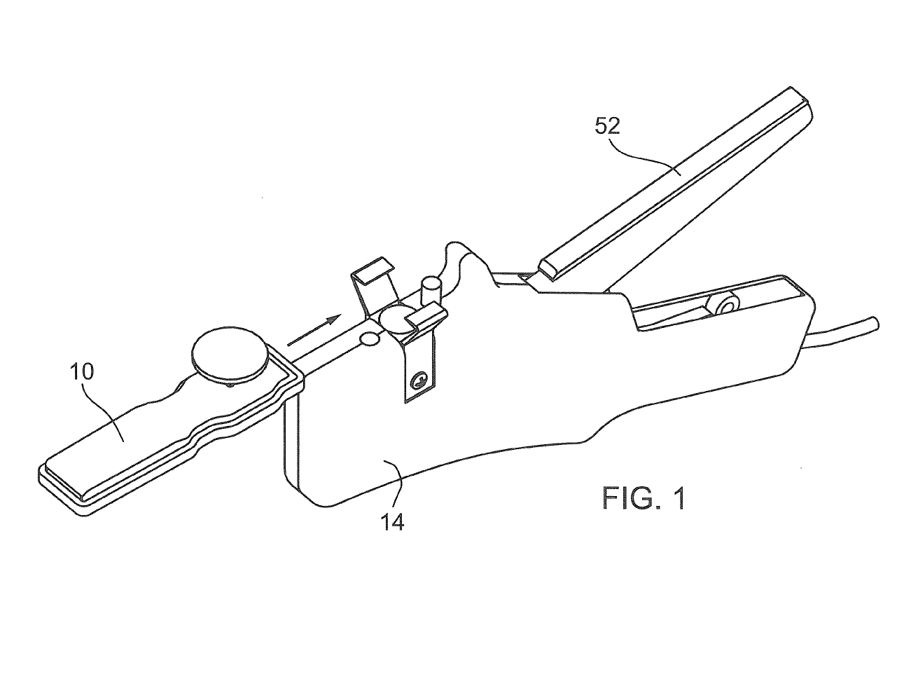

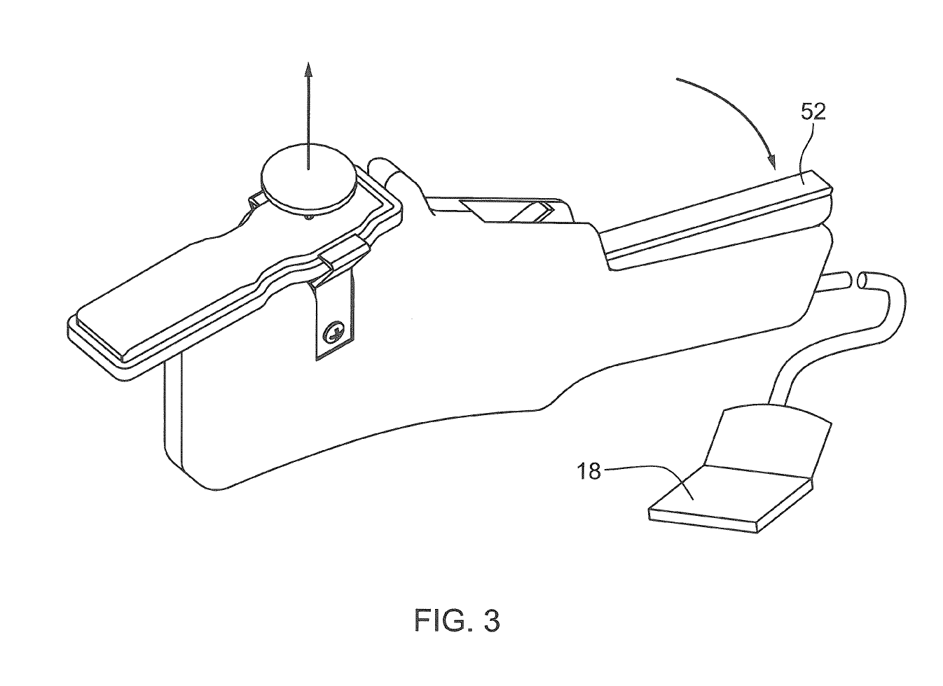

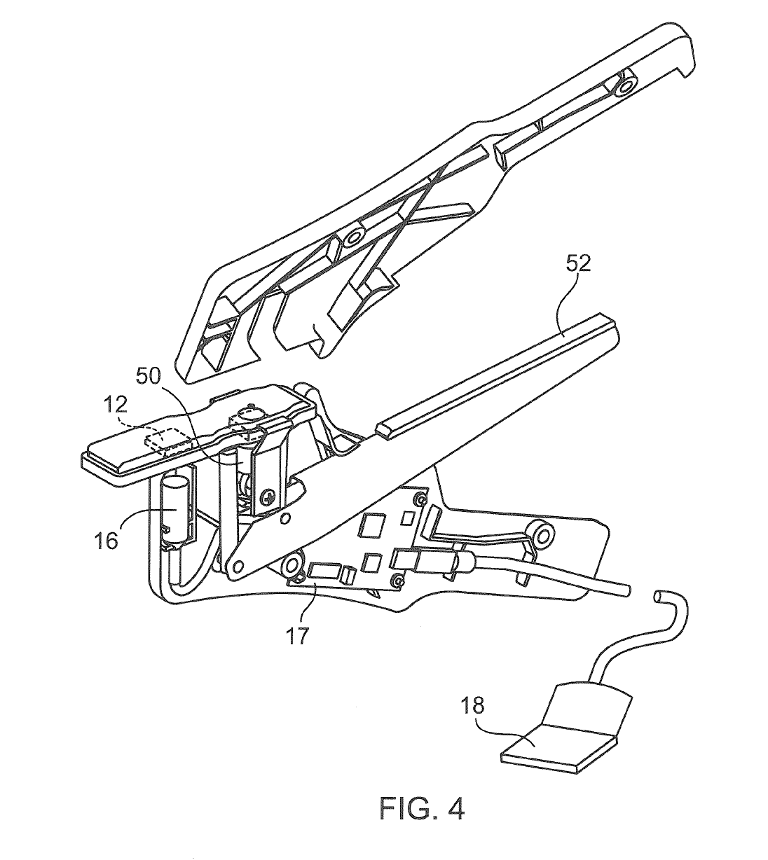

Referring to FIGS. 1 and 4 the RFID security tag based monitoring system of the present invention includes a security tag 10 with an RFID chip 12 (shown in FIG. 4) therein and a security tag smart detacher 14 with a RFID reader 16 (shown in FIG. 4) operably attached thereto. The reader 16 is operably attached or attachable to a control system 18 (shown in FIGS. 3 and 4). The detachers may be connected either wirelessly as shown in FIG. 3 or wired as shown in FIG. 4.

The RFID chip 12 in the security tag includes an antenna.

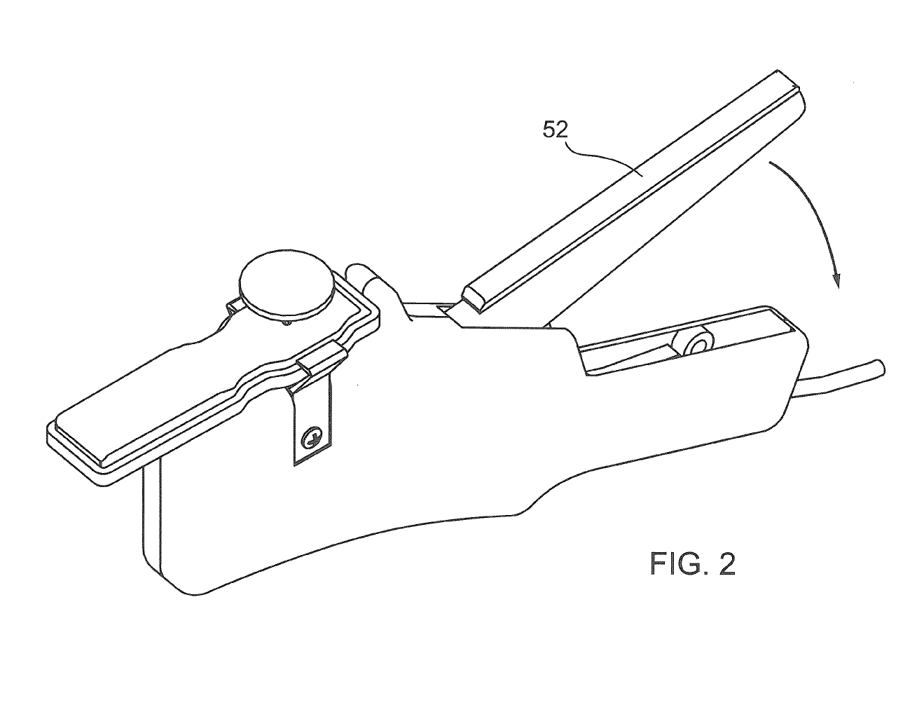

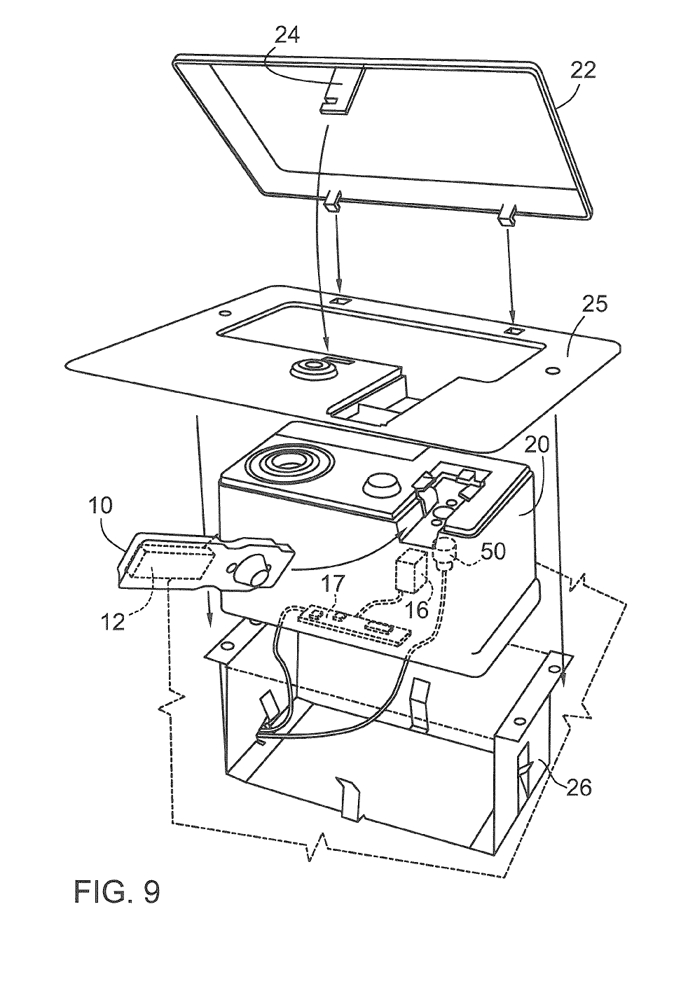

The smart detacher may be a handheld detacher 14 as shown in FIGS. 1 to 6 or a stationary detacher 20 as shown in FIG. 9. The stationary detacher 20 may be a power detacher that can handle multiple different kinds of security tags. Preferably the RFID reader 16 is a near field reader. The reader is capable of reading RFID chip in the security tag 10. The reader 16 is positioned such that when RFID antenna is placed into the detacher the reader can record the moment the tag and pin is released from the product. The RFID reader 16 is typically attached to a circuit board 17. The RFID reader 16 may be a reader and writer.

The RFID reader is operably connected to a control system 18 and the control system records the number of tags removed and the time that they are removed. This information can then be compared with information from the associated cash register which is collected at the point of sale. The handheld detacher 14 may be connected to a power source. The power source may be a battery or it may be connected to a power socket. If power source is battery the information is stored on the detacher until the detacher is connected to a control system which may concurrently charge the battery.

The stationary detacher 20 may include lid 22 that has a lock 24 thereby when a person opens their cash register they also unlock the reader 20 thereby ensuring that others cannot remove a tag 10 when there is no sale. Preferably stationary detacher is housed under a countertop and plate 26 is flush with the countertop (not shown). A holder 28 may be secured under the countertop and the plate 25 is attached to the top of the countertop with the detacher 20 secured therebetween. The handheld detacher 14 may also include a lock. As well, the retailer may require the employee to have an identification tag that includes an RFID chip and antennae and the employee may be required to have their tag read prior to detaching tags. Typically the stationary detacher is located new the point of sale. It will be appreciated that a handheld detacher may also be located at the point of sale. Information from the detacher may be incorporated into the point of sale information collected by the retailer. Further security may be added to the detachers, for example the detacher may include an unlocking feature wherein the user has to enter a user ID, provide biometric data, or read their employee ID before the detacher becomes functional.

It will be appreciated by those skilled in that art that the detachers and the system disclosed herein may be used with a wide variety of tags. Specifically they may be used with the dual lock tags disclosed in U.S. Pat. No. 8,051,686 issued to Glen Walter Garner on Nov. 8, 2011 or the more conventional tags used commonly in the industry. The tags may be spring lock tags or magnetic lock tags or a combination thereof.

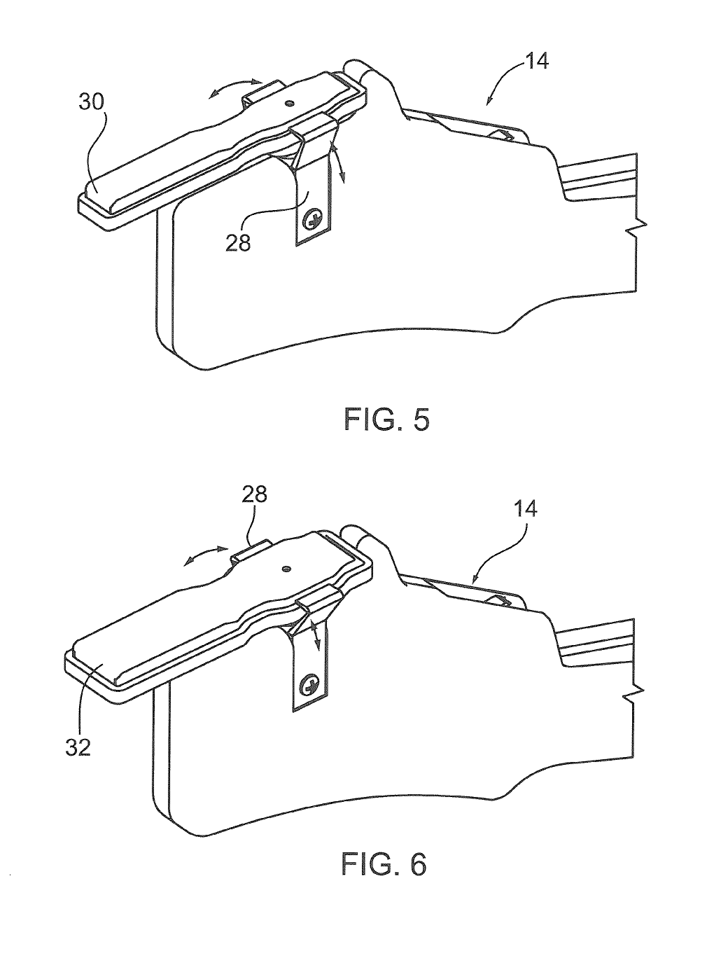

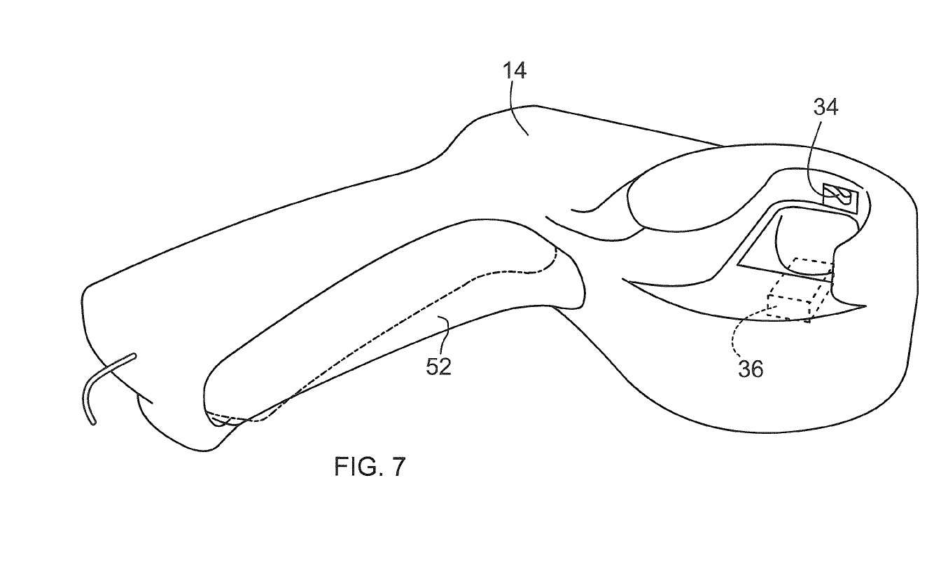

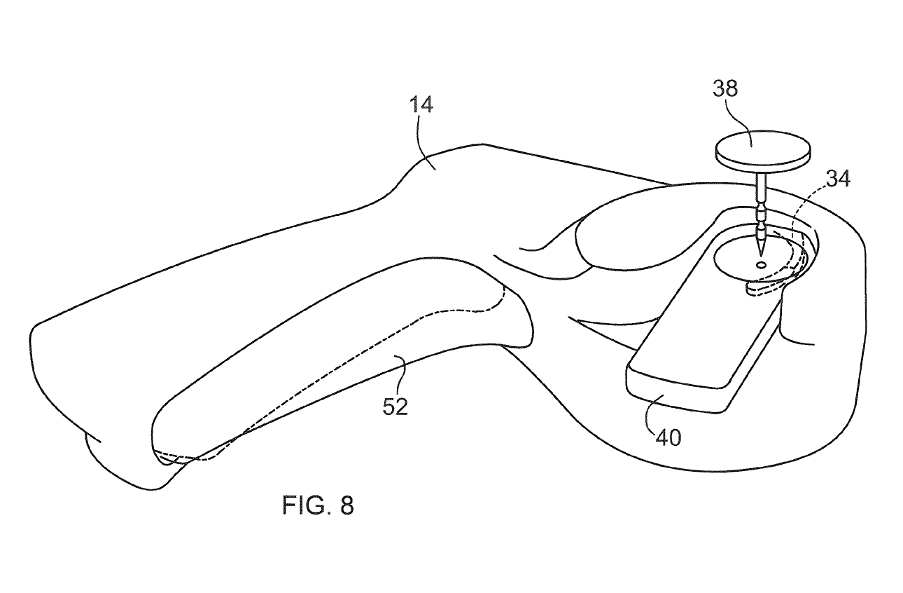

Examples of some variations on the detacher are shown in FIGS. 5 to 8. For example arms 28 which help to hold the tags in place may be moved inwardly to accommodate a slimmer security tag 30 as shown in FIG. 5 or alternatively arms 28 may be moved outwardly as shown in FIG. 6 to accommodate a wider security tag 32. As well, detacher 14 may include an arcuate arm 34 which may be used in conjunction with a magnet 36 for releasing a pin 38 from tag 40. The arcuate arm 34 is for use in association with a spring lock and is similar to the spring lock shown in Spring lock 40 is disclosed in U.S. Pat. No. 5,426,419 issued to Nguyen et al. on Jun. 20, 1995. It will be appreciated that the security tag may include a magnetic lock and/or a spring lock and the detacher may be configured to work with specific tags.

Internal Theft is a major issue and is consider similar or higher than external theft. Low paying staff can easily today remove a tag 10 from a garment or other product and blame the loss on external theft. Some retailers have also loss faith with EAS (electronic article surveillance) and have chosen to implement CCTV (closed circuit television) or digital cameras to monitor staff and customer actions. CCTV can record actions however when the retailer has a lot of stores and many cameras it is not very easy to identify any individual theft.

With readers embedded into hand detachers 14 and power detachers 20 the number of times a security tag 10 is removed from a product can be recorded. The daily, weekly, monthly detagging actions can be downloaded from the detacher to the main computer and with software can compare the actions of actual sales to detagging. Through statistical reporting and software a Loss Prevention officer managing for example two hundred stores can get RED FLAG or warnings of unusual usage. For example should there be ten cash sales and fifteen items have been detagged the difference is a warning that suspicious actions has occurred.

This will help identify the areas that need focus on in a group of for example two hundred stores.

The stationary detacher 20 and hand detacher 14 with an RFID reader 16 can also help in other areas such as ensuring only branded products are being sold and not copies or other stock has been sold. Copies of Branded items is also a major problem with Designers losing out to cheaper or less quality units that can hurt or damage their brand image.

By adding in an RFID chip 12 and antenna to a security tag 10 and RFID readers 16, the retailer can control and monitor that only specific security tags 10 are being used. Through software encryption the readers can only read the specific tag which will protect both the tag and the branded product from copies.

By way of example, a major Designer prefers to have a means of tagging that's more secure. The Designer manufacture can encrypt the RFID chip 12 in the original tag 10 at the time of manufacture and introduce their own signature or a predetermined identification number or code and attached the encrypted tag 10. The encrypted tag 10 would be attached to the product through shipping and distribution through to the sale, wherein the RFID reader 16 can read the RFID chip and determine if it is encrypted with the signature or identification number and thus a genuine product. If it is not an encrypted tag 10 the Designer then knows that a counterfeit product has been mixed with their products. This may also be achieved through the use of specific unique identifiers or TID's (transaction identifiers) that many manufacturers include on every chip. Accordingly the user knows that only specific TID's are part of their inventory and therefore if there is a TID not included then this is likely a counterfeit product.

Retailers have been reviewing RFID for many years. The only current real success is the controlling and movement of large pallets or skids where a large RFID chip with antenna is placed on the whole skid. In other industries such as the medical and defense industries the application of RFID is widely used. New passports today use RFID and the near field readers can read the close proximity of the passport. In the retail environment there are concerns over privacy laws with regard to having an RFID antenna embedded into the garment. The concern is that if an RFID chip is permanently attached to the product more information than most consumers want might be readily available to anyone with an RFID reader. The smaller and the longer RFID antennas work well with near field readers, however far field readers DO have a problem reading the tag. Simply physics, RFID antennas need to be large to be read by a far field antenna. Retailers do not want larger antennas as they cost more too. The cost of each RFID antenna can cost from 8 to 20 cents per unit. The reusability of a thin label is minimal as the construction is fragile. Inserting the RFID chip and antenna into a plastic hard security tag 10 is an option that allows for the RFID to be reusable and keep marginal costs down. The RFID inlay or chip inside tag 10 may be supplied by a number of RFID inlay manufacturers. Typically an inlay is made up of chip with an antenna. The chip is adhered to the inlay. The frequency range for the UHF RFID inlay is from the range of 880 Mhz to 960 Mhz and 2.45 GHz. There are other frequency ranges available in the lower frequency belt such as eg 1.95 Mhz, 2 Mhz, 3.25 Mhz, 4.8 Mhz, 8.2 Mhz, 9.5 Mhz and 13.54 MHz. It will be appreciated by those skilled in the art that the detachers 14 and 20 and the system described herein may be configured readers to read any frequency range. As well, the detachers may be configured to combine frequency so that the detacher can read a multitude of frequency ranges or a combination of frequency ranges. For example, there could be a combination of inlays for example a larger UHF inlay and a smaller UHF inlay or a larger UHF inlay with an alternative frequency band such as HF or Low Frequency such as the 13.54 Mhz. The combination of inlays and TID in one tag provides further security against counterfeiting or any form of added security. In addition to the RFID inlays or tags a UPC (universal product code) barcode may also be used to track the merchandise. In that instance the handheld detacher and the stationary detacher may further include a UPC barcode reader. Note that tags may also be active tags wherein a battery is added to the antenna. The advantage is that the antenna and active tags can be in constant connection but the disadvantage is the battery life and cost. There are advantages for an active tag as three antennas could be used in say a department store floor. Each antenna sees the same active tag and can co-ordinate the position of the tag at any given time.

The RFID tags may provide further usability to the retailer. For example the retailer may write an EPC (electronic product code) onto the tag. Thus at the check-out when the tag is scanned it can be confirmed that the tag and the product correspond. In addition, it readers were set up around the store a consumer might read a tag and then query regarding availability in other sizes, colours etc. The EPC may be written such that it can only be changed with a specific password. This further feature would reduce the chance to copy a tag 10.

The security features of the detachers may be further enhanced by having the magnetic detacher being an electromagnetic detacher. A schematic example of this is shown in FIG. 4 and FIG. 9 at 50. Instead of using a magnet that is fixed in the detacher an example of which is shown in FIG. 36, a powered electromagnetic magnet could be used so that the hand detacher only detaches when the electromagnetic is powered. According the level of security may be increased by configuring the electromagnetic magnet to be operably when the tag is confirmed to be a correct tag. In use the tag slides into the hand detacher 14 or the stationary detacher 20, when the lever 52 the RFID reader built into the detacher asks the RFID inlay or inlays inside the tag “are you a recognized inlay?”, that information is sent back to the host (mini computer) and the host says YES, power the electromagnetic coil which allows the opening of the tag. The user may also need to perform the action of a password or a biometrics such as a finger print acknowledgement so that the host or computer is authorized or “allowed” to use of the powered or regular hand detacher.

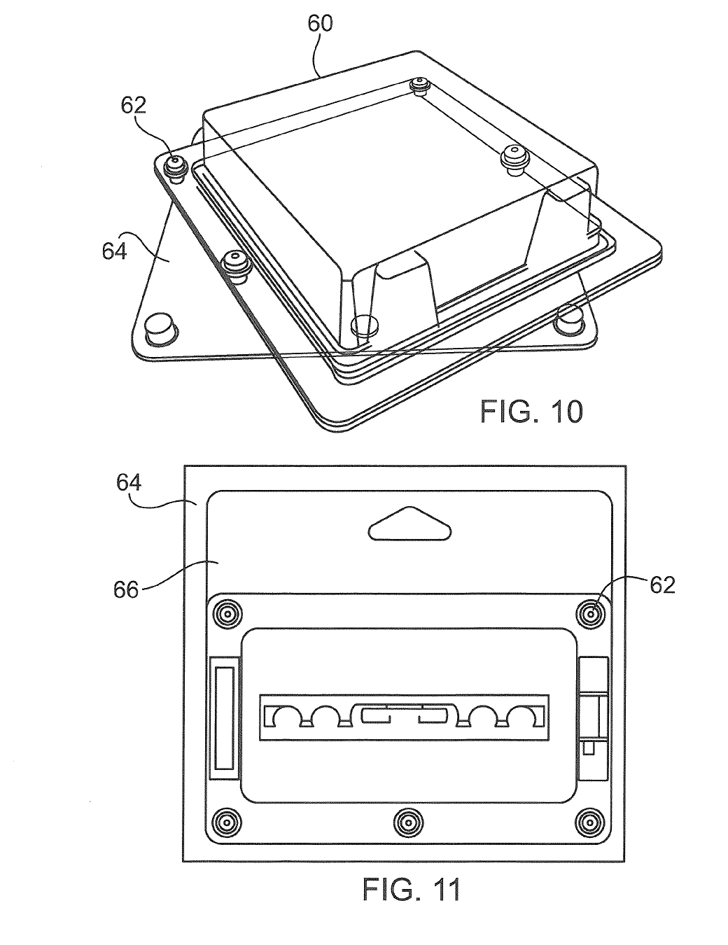

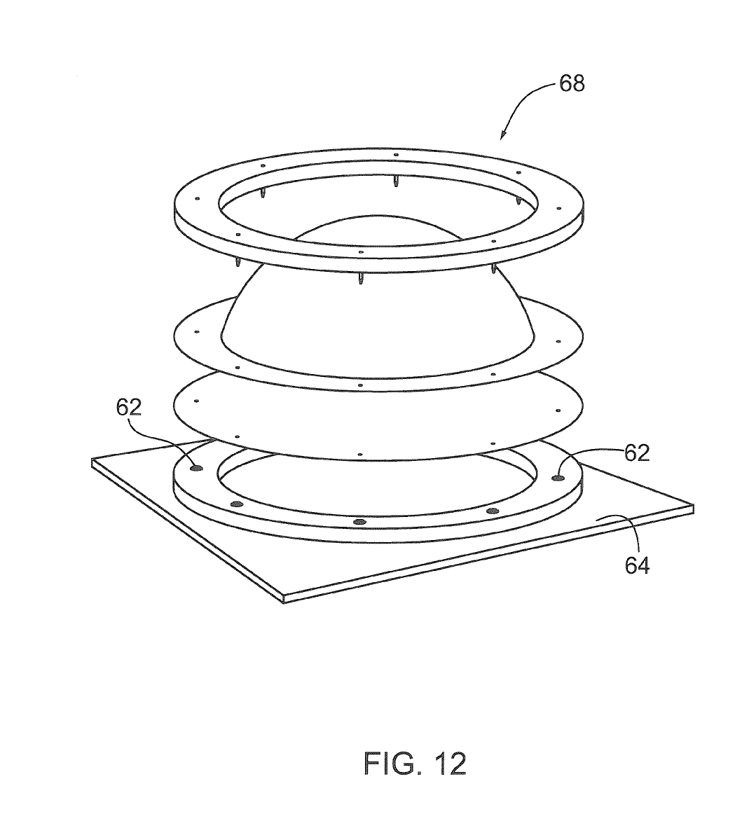

The electromagnetic feature could also be used to detachers having multiple releasers that may be used with items that have multiple locks. It will be appreciated that the package and the detacher may take a number of different shapes. Some examples of this are shown in FIGS. 10, 11 and 12. Specifically figure shows a clam shell type package 60 with multiple locks 62 which is shown over a stationary detacher that has plurality of electromagnetic detachers. An alternate package 66 is shown in FIG. 11 and a further alternate package is shown at 68 in FIG. 12. This is particularly powerful wherein different sized and shaped products are to be used with the same detacher because the electromagnetic detachers that are activated can be configured to correspond with the particular item. For example, when the packaging is laid on the electromagnetics, the RFID reader sees the RFID inlay and automatically tells the detacher this is package size x for store company Y and automatically powers the coils that opens the corresponding locks. By way of example, there are three different retailers. Retail X may have locks 1 and 2 and 3 open, store No Y may have lock 2 and lock 3 and lock 4 and lock 5 open. Store Z may have a detacher that requires lock 1 and lock 3 and lock 6 to open. The combination of opening different locks for different users also added further security features. Similarly the hand detacher may be configured to have more than one magnetic lock opener and the detacher may include electromagnetic detachers and/or conventional magnets. As well the detachers could be configured to include both electromagnet releasers and conventional magnets.

In use there is a method of monitoring using a security tag with an RFID chip therein and an detacher having an RFID reader operably connected thereto. The method includes the steps of: writing information onto the RFID chip; attaching the security tag to a product; detaching the security tag from the product and reading the information on the RFID chip; and forwarding the information to a control system.

The information forwarded to the control system includes a date and a time of reading the information from the RFID chip. The RFID reader may be associated with a cash register at the point of sale and the information from the RFID chip and the date and time of reading the information is compared to information from the cash registered. Discrepancies between the information from the RFID chip and the cash registered may be red flagged.

The security tag may be attached to the product at a manufacturer of the product.

The information may include a predetermined identification code and further including the step of determining if the information read includes the predetermined identification code and if not red flagging the product.

Additional RFID readers may be positioned at different locations around the store to provide different opportunities for obtaining information. For example the RFID readers may be positioned where products enter a store and the information may be read when the product enters the store. In addition or alternatively the RFID readers may be located at predetermined locations around a store and periodically information may be read within range of each RFID readers and the location of predetermined identification code may be determined relative an RFID reader. RFID readers may be located in a change rooms and a number of tags may be read entering the change room and a number of tags may be read leaving the change room and red flags may be determined when these numbers are not the same.

However, there are many perceived barriers to using RFID technology in retail establishments. Accordingly retail pathway for retailers has been developed.
The Retail Pathway for Retailers:
STEP 1: Add an RFID antenna to security tag. Preferably the security tag that is used is a dual locking tag disclosed in U.S. Pat. No. 8,051,686 issued to Glen Walter Garner on Nov. 8, 2011, incorporated herein by reference (however, it will be appreciated by those skilled in the art that the monitoring system described herein could also be used with other designs of security tags);
STEP 2: Write to each tag to give its own individual identification number or code;
STEP 3: Introduce RFID readers 16 to the detacher method to control internal theft: Comparing De-tagging to actual cash register sales
Note: The readers are very affordable for the retailer. The near field readers are less than 500 dollars and therefore the investment is nominal compared to having readers throughout the whole store.
STEP 4: Prove Step 3 reduces internal theft which is often considered higher than external theft.
The savings here can now be applied to the next application for the retailer
STEP 5: Retailers can start to apply new usage to an already purchased intelligent security tag: The RFID antennas in the hard tag can be read too or re-written too 100,000 times or more . . . see applications below and the growth of RFID within the retail arena.
   (a) Reading items moving in or out of changing rooms. Simply counting how many went in and how many came out.
   Modules that can read an RFID tag are readily available. 6 ft width of exits is very manageable
   (b) More writers will be sold to manufacturers of garments as then they can have more useful information in the tag: example: Time of manufacture, type of cotton, color, size, date of manufacture, destination etc.
   (c) Foil lined bag theft: Readers within the store that can read when 5 items or more are sold of the same type. A group of items are placed inside a foil lined bag. The aluminum will screen the tag from detection and therefore the EAS or RFID antenna cannot be read. However with the software available, the fast action or movement of items can be signaled to the reader with software that removal maybe illicit.
   (d) Often high end department stores have high value items wherein it is unlikely that more than one such item is sold at a time. The software can provide a warning to security that these items have moved. This information can be linked to security cameras thereby increasing the likelihood of capturing the illicit removal.
   (e) Inventory Counter: Inventory can be counted more often at a lesser cost. monCurrently the UPC barcode has to be read individually. A hand held reader can scan more products at any give time. With regard to the non reading of a tag this will occur. The advantage though again with the help of software, you can scan at different times and the software can recognize the items that may have been missed on a previous scan. Overlapping of statistical data can be used regularly and therefore the information can be more accurate.
   (f) DISTRIBUTION: With the distribution of garments with freight companies (sometimes delivery at night) the readers can record the moment the items have arrived at that store. Out tags with the unique locking mechanism can be made to any length using the current UHF RFID antennas
   (g) Marketing: Linking Products together: Retailers can read the tag on a particular garment, for example a jacket and automatically another item can be linked to that item for example a belt or scarf. This could help sell more items and provide the customer with another interesting item of clothing.

Many marketing tools can be applied to the new tag with the way they promote the tag. For example: Today you have won an extra 100 Air Mile. In the changing rooms there can be LCD Display that can show the same item in different colours or matched with different items.

It will be appreciated by those skilled in the art that the RFID chip may be attached to a new field antennae and a far field antenna to increase the functionality of the tag. For example, two Antennas and a Chip may be laid on a substrate. Antenna 1 is for NFC Near field communication or more private communication. The RFID reader 16 in the hand detacher 14 or a stationary detacher 20, can read the RFID chip using the near field antenna. As communication from the reader to the tag is so close there is a very high rate of detection or reading.

The information collected can be as simple as each tag has a different number and the software can help you with the information on how many times its been used in a week, month, year or more. The RFID chip can hold any information subject to what the user wishes want to write to it. This element is very similar to the values held in a UPC Barcode which also requires a close read.

The second antenna, typically the larger of the two antennas, may be for FFC (Far field Communication) or public communication. The larger antenna may have different information to the NFC. It may be used as an EAS advice. The wide exit systems that may require readers in the ceiling or the floor and subject to the size of the antenna used can read the tag. Should the RFID readers be flooding an area, if a tag moves into one part of that area through software they can see the movement. If the tag came within two feet or three feet of the exit an alarm could sound.

Preferably the security tag 10 shown herein can be used with traditional EAS systems. The retailer can have the same tag that can be read by the readers on UHF as well as the same tag will set off the older system at the exits. Typical EAS bands used in the market are the following frequencies: 58 khz, Electro-magnetic, 8.2 Mhz and 915 Mhz Microwave (Older system developed in the 70s)

In addition, an old security tag may be updated by adding a battery and an RFID chip and antenna.

Accordingly, RFID security tag based monitoring system in association with dual locking tag with RFID that can open the doors and help them to develop RFID or intelligence into their business and can be used by different departments eg: Loss Prevention, Distribution, Marketing, Financial etc. Having more departments involved helps the retailer to find the budget to invest. Further, it has the advantage that the RFID chip is not permanently attached to the product, something with which many consumers are not comfortable. As well, since the RFID tag is reusable, it is more environmentally friendly than an RFID chip that is attached to a product and thus only used once. Typically an RFID chip may be written to or read more than 100,000 times.

Generally speaking, the systems described herein are directed to security tag systems. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to security tag systems.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

1. A smart detacher for use in association with a tag having an RFID chip therein comprising:
a detacher; and
an RFID reader.

2. The smart detacher of claim 1 wherein smart detacher is one of a handheld detacher and a stationary detacher.

3. The smart detacher of claim 1 wherein the detacher is a detacher for spring lock.

4. The smart detacher of claim 1 wherein the detacher is a detacher for a magnetic lock.

5. The smart detacher of claim 1 wherein the detacher is a detacher for a combination spring lock and magnetic lock.

6. The smart detacher of claim 4 wherein the detacher is an electromagnetic detacher.

7. The smart detacher of claim 3 wherein the detacher includes an arcuate arm for detaching the spring lock.

8. The smart detacher of claim 1 wherein the RFID reader is an RFID reader and writer.

9. The smart detacher of claim 1 wherein the RFID reader is operably connected to a control system.

10. The smart detacher of claim 1 wherein the RFID reader is connected to the control system by way of one of a wireless connection and a wired connection.

11. The smart detacher of claim 1 wherein the RFID reader is operably connected to a power source.

12. The smart detacher of claim 11 wherein the power source is one of a battery and a power socket.

13. The smart detacher of claim 1 further including a UPC barcode reader.

14. The smart detacher of claim 1 wherein the tag is an active tag.

15. A method of monitoring using a security tag with an RFID chip therein and an detacher having an RFID reader operably connected thereto comprising the steps of:
writing information onto the RFID chip;
attaching the security tag to a product;
detaching the security tag from the product and reading the information on the RFID chip; and
forwarding the information to a control system.

16. The method of claim 15 wherein the control system further records a date and a time of reading the information from the RFID chip.

17. The method of claim 16 wherein the RFID reader is associated with a cash register and the information from the RFID chip and the date and time of reading the information is compared to information from the cash registered.

18. The method of claim 17 wherein discrepancies between the information from the RFID chip and the cash registered are red flagged.

19. The method of any one of claim 15 wherein the detacher is one of a handheld detacher and a stationary detacher.

20. The method of any one of claim 15 wherein the security tag is attached to the product at a manufacturer of the product.

21. The method of claim 20 wherein the information includes a predetermined identification code and further including the step of determining if the information read includes the predetermined identification code and if not red flagging the product.

22. The method of claim 20 further including RFID readers where products enter a store and reading the information when the product enters the store.

23. The method of claim 20 further including locating RFID readers at predetermined locations around a store and periodically reading RFID information within range of each RFID readers and determining the location predetermined identification code relative an RFID reader.

24. The method of claim 15 further including RFID readers a change rooms and further including the step of reading a number of tags entering the change room and reading a number of tags leaving the change room and red flagging when these numbers are not the same.

25. The method of claim 15 wherein the detacher is a detacher for spring lock.

26. The method of claim 15 wherein the detacher is a detacher for a magnetic lock.

27. The method of claim 15 wherein the detacher is a detacher for a combination spring lock and magnetic lock.

28. (canceled)

29. (canceled)

30. The method of claim 15 wherein the RFID reader is an RFID reader and writer.

31. The method of claim 15 wherein the RFID reader is connected to the control system by way of one of a wireless connection and a wired connection.

32. The method of claim 15 wherein the RFID reader is operably connected to a power source.

33. The method of claim 32 wherein the power source is one of a battery and a power socket.

34. The method of claim 15 wherein the security tag is an active tag.
